(19) United States
(12) Patent Application Publication
(10) Pub. No.: US 2026/0071814 A1
(43) Pub. Date: Mar. 12, 2026

(54) CONTINUOUS-OPERATION UMBRELLA DRYING MACHINE

(71) Applicant: Yi-Kun CHANG, Taoyuan City (TW)

(72) Inventor: Yi-Kun CHANG, Taoyuan City (TW)

(21) Appl. No.: 19/387,439

(22) Filed: Nov. 12, 2025

(30) Foreign Application Priority Data
Nov. 13, 2024 (TW) 113212373

(51) Int. Cl. F26B 5/16; A47G 25/12

(52) U.S. Cl. CPC F26B 5/16; A47G 25/12; F26B 2210/10

(57) ABSTRACT

Disclosed is a continuous-operation umbrella drying machine, comprising a base body, a first water-absorption module, a second water-absorption module, and a rail frame. The rail frame has a closed end and an open end, with the open end connected to two side walls of the base body. A sliding section is provided between the open and closed ends. In use, an umbrella enters a passage from the open end and hangs on the rail frame. By the rotation driven by the first water-absorption module, rainwater is absorbed by first and second water-absorption elements, after which it slides to the closed end to complete the drying process.

### FIELD OF THE INVENTION

The present invention relates to a technical field of umbrella drip prevention, and more particularly to a continuous-operation umbrella drying machine that operates continuously and at high speed, and is suitable for use in public places with heavy pedestrian traffic.

### BACKGROUND OF THE INVENTION

Umbrellas, a commonplace everyday item, create a subtle conflict between convenience and environmental protection. On one hand, umbrellas provide us shelter on rainy days, offering convenience; on the other hand, handling umbrellas after use has become troublesome.

Traditional umbrella storage methods, such as dedicated containers or umbrella stands, are simple and easy to implement but come with several drawbacks. Firstly, these methods cannot effectively handle crowded places, often resulting in overcrowded umbrella stands and even lost umbrellas. Secondly, open umbrella stands cannot effectively prevent water from dripping, which easily results in wet floors.

To address these issues, single-use plastic umbrella covers were introduced. However, this seemingly convenient solution causes new problems. Umbrella tips easily puncture the plastic covers, allowing water to leak and drip, which not only fails to keep floors dry but also increases the risk of slipping. More importantly, the large amount of discarded plastic umbrella covers causes significant environmental pollution. Although some locations provide recycling facilities, the decomposition cycle of plastic waste is long, and its impact on the ecosystem cannot be underestimated.

It is noteworthy that the production process of plastic umbrella covers consumes substantial energy and resources. From crude oil extraction to plastic product manufacturing, each step negatively impacts the environment. Therefore, plastic umbrella covers not only cause pollution during use but also contradict environmental protection principles during production.

In comparison, traditional umbrella storage methods and single-use plastic covers have respective drawbacks. The former cannot effectively solve the storage problem for large quantities of umbrellas, while the latter causes significant environmental pollution. This dilemma highlights the importance of balancing convenience with environmental protection. Finding a way to handle umbrellas that meets people's needs while reducing the burden on the environment is a challenge that urgently needs to be addressed.

To address these drawbacks, some innovative technologies have emerged, such as the applicant's Taiwan patent applications No. 112205869 titled “Umbrella Drying Machine” and No. 113129207 titled “Improved Structure and Application Method of Umbrella Drying Machine.” These patents disclose umbrella drying machines capable of effectively removing residual water from umbrella surfaces, reducing the risk of slipping on the ground and minimizing environmental pollution. However, these technologies still face challenges, such as single-umbrella designs suitable only for drying one umbrella at a time, which cannot meet the demand for simultaneous drying of multiple umbrellas in crowded places. Especially in public venues or peak hours, the single-umbrella drying limitation reduces equipment efficiency and fails to satisfy the need for immediate drying of multiple umbrellas.

In view of the above drawbacks, the inventor has conducted research and improvements, resulting in the present invention.

### SUMMARY OF THE INVENTION

The primary objective of the present invention is to provide a continuous-operation umbrella drying machine capable of automatically removing residual water from umbrellas.

The secondary objective of the present invention is to provide a continuous-operation umbrella drying machine that operates continuously and at high speed.

Another objective of the present invention is to provide a continuous-operation umbrella drying machine suitable for public places with heavy pedestrian traffic.

To achieve the aforementioned objectives and effects, the technical means adopted by the present invention include a base body, a first water-absorption module, a second water-absorption module, and a rail frame, wherein:

The base body has a first side wall and a second side wall, a first recess and a second recess are respectively provided in the first side wall and the second side wall, a passage is provided between the first recess and the second recess, and the base body is provided at a bottom of the base body an accommodating space in communication with the passage.

The first water-absorption module is disposed within the first recess and includes a plurality of first water-absorption elements, each having two ends respectively rotatably mounted to a top and a bottom of the first recess, the plurality of first water-absorption elements being connected by a linkage assembly, and the linkage assembly being driven by a drive element.

The second water-absorption module is disposed within the second recess and includes a plurality of positioning seats respectively connected to a top and a bottom of the second recess, and a plurality of second water-absorption elements rotatably mounted on the positioning seats.

The rail frame has a closed end and an open end, wherein a sliding section is provided between the open end and the closed end, the open end extends downward and is connected to the first side wall and the second side wall such that the open end and the sliding section directly face toward the passage.

According to the aforementioned structure, a water-receiving plate is respectively provided at bottoms of the first recess and the second recess.

According to the aforementioned structure, an automatic drain valve is provided at the bottom of the base body.

According to the aforementioned structure, the open end extends downward and is provided with a fixing seat connected to the first side wall and the second side wall.

According to the aforementioned structure, the linkage assembly includes a plurality of axially rotatable elements each assembled at one end of the plurality of first water-absorption elements, and a plurality of linkage elements respectively connected to the plurality of axially rotatable elements.

According to the aforementioned structure, the plurality of axially rotatable elements and the plurality of linkage elements are combinations of a plurality of gears and a plurality of racks, a plurality of gears and a plurality of chains, or a plurality of pulleys and a plurality of belts.

According to the aforementioned structure, two ends of the positioning seats are respectively provided with power elements.

According to the aforementioned structure, a position where the passage directly faces toward the open end is defined as an entrance, and a position where the passage directly faces toward the closed end is defined as an exit.

According to the aforementioned structure, the drive element is further electrically connected to a blocking sensor, the blocking sensor being connected to the first side wall or the second side wall.

According to the aforementioned structure, the first water-absorption module and the second water-absorption module are cylindrical modules made of sodium polyacrylate (SPA), super absorbent polymer (SAP), polyvinyl alcohol (PVA), cellulose sponge, polyurethane foam (PU foam), silicone sponge, or thermoplastic elastomer (TPE).

### BRIEF DESCRIPTION OF THE DRAWINGS

To enable a more concrete understanding of the above objectives, effects, and characteristics of the present invention, the following detailed description is provided with reference to the accompanying drawings:

FIG. 1 is a perspective view of a preferred embodiment of the present invention.

FIG. 2 is a perspective exploded view 1 of the preferred embodiment of the present invention.

FIG. 3 is a perspective exploded view 2 of the preferred embodiment of the present invention.

FIG. 4 is a cross-sectional view 1 of the preferred embodiment of the present invention.

FIG. 5 is a cross-sectional view 2 of the preferred embodiment of the present invention.

### DETAILED DESCRIPTION OF THE PREFERRED EMBODIMENTS

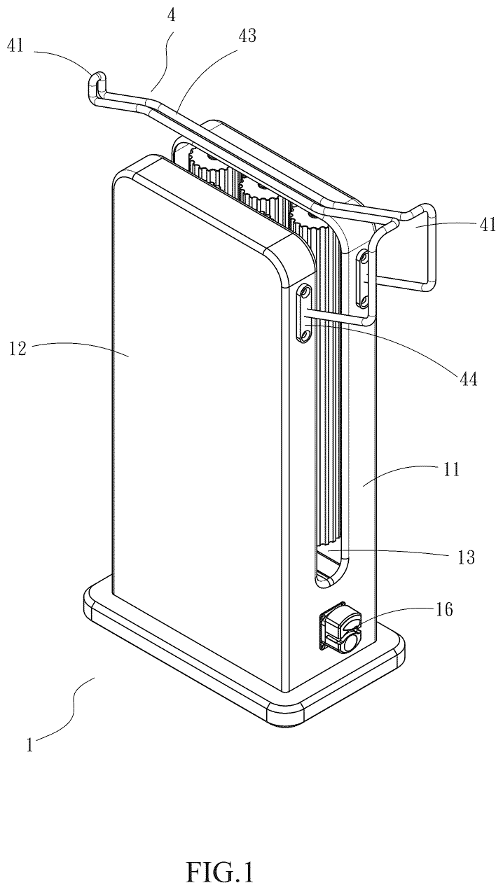

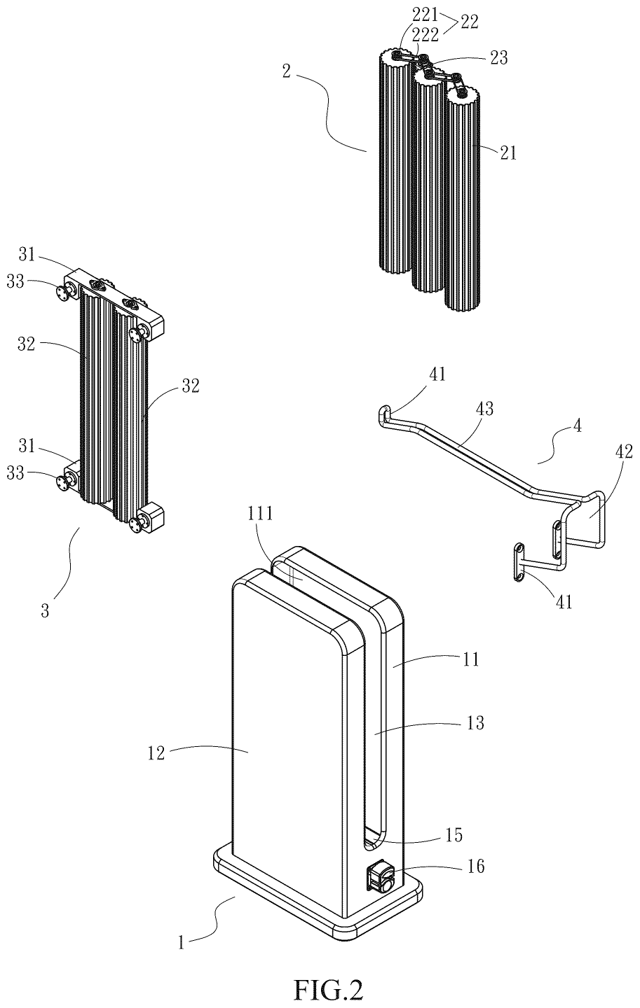

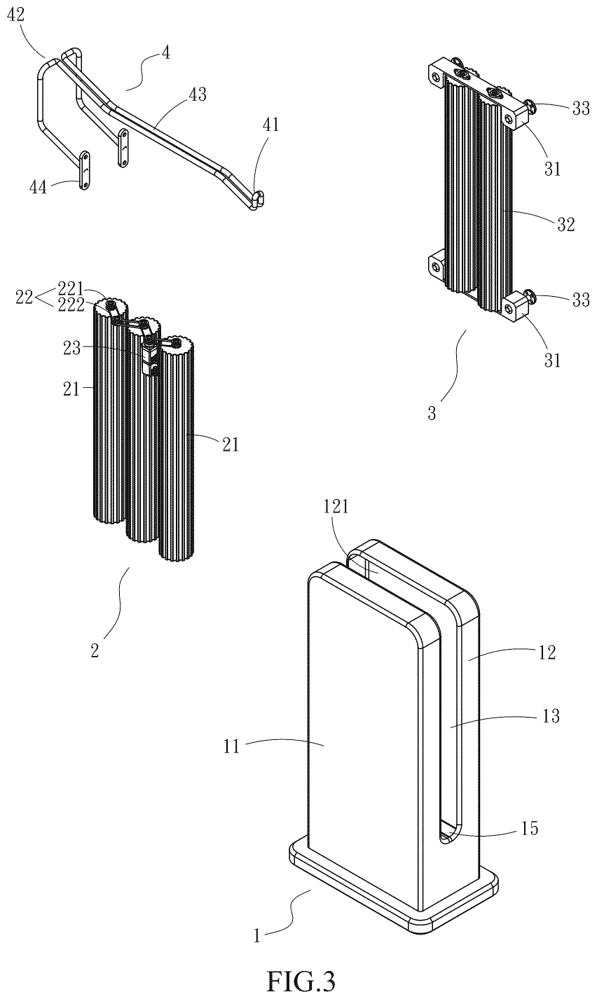

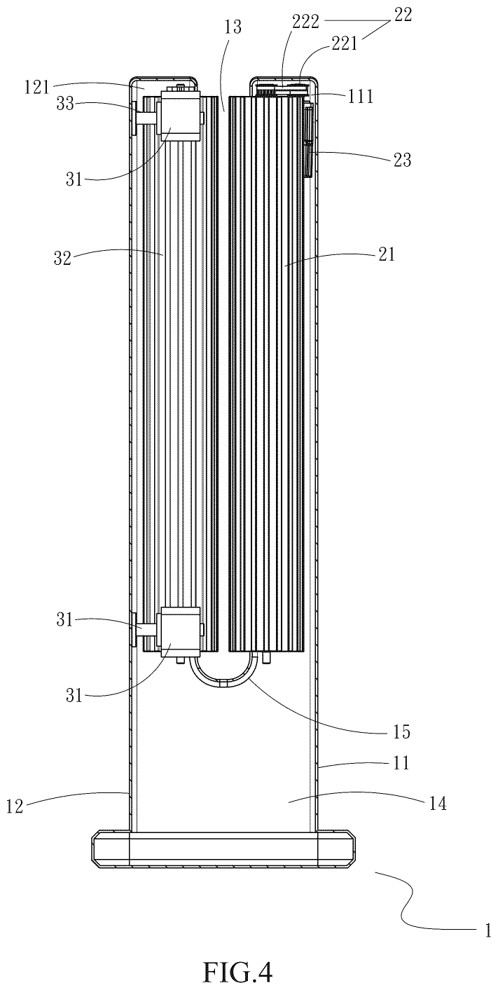

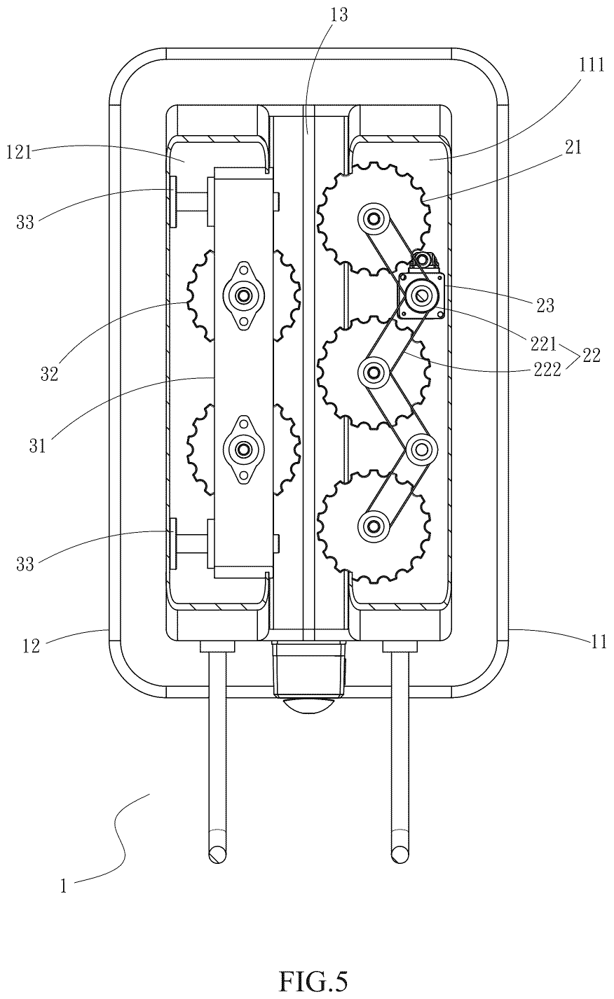

Referring to FIGS. 1 to 5, the structure of the present invention mainly includes a base body 1, a first water-absorption module 2, a second water-absorption module 3 and a rail frame 4. The combination and functions of each component are as follows:

The base body 1 has a first side wall 11 and a second side wall 12. A first recess 111 and a second recess 121 are respectively provided inside the first side wall 11 and the second side wall 12. A passage 13 communicates between the first recess 111 and the second recess 121, forming a space for accommodating an umbrella and performing water absorption. The bottom of the base body 1 has an accommodating space 14 for collecting water and is bottom with an automatic drain valve 16 for periodically discharging accumulated water. Water-receiving plates 15 are respectively disposed at the bottoms of the first recess 111 and the second recess 121 to facilitate water concentration and its flow into the accommodating space 14.

The first water-absorption module 2 is disposed within the first recess 111 and comprises a plurality of first water-absorption elements 21, a linkage assembly 22, and a drive element 23. The first water-absorption elements 21 are cylindrical elements made of water-absorbent materials such as sodium polyacrylate (SPA), super absorbent polymer (SAP), polyvinyl alcohol (PVA), cellulose sponge, polyurethane foam (PU foam), silicone sponge, or thermoplastic elastomer (TPE). Each first water-absorption element 21 has two end rotatably mounted to the top and bottom of the first recess 111. The linkage assembly 22 comprises a plurality of axially rotatable elements 221 and linkage elements 222. The axially rotatable elements 221 and the linkage elements 222 may be combinations of gears and racks, gears and chains, or pulleys and belts. In the present embodiment, the axially rotatable elements 221 and the linkage elements 222 are respectively implemented as pulleys and belts. The linkage assembly 22 drives the first water-absorption elements 21 to perform squeezing and releasing actions to enhance water absorption efficiency. The drive element 23 is connected to the linkage assembly 22 and electrically connected to a blocking sensor (not shown). The blocking sensor is disposed on the first side wall 11 or the second side wall 12 to detect whether an umbrella has entered the passage 13 and control the operation of the drive element 23.

The second water-absorption module 3 is disposed within the second recess 121 and comprises a plurality of positioning seats 31 and a plurality of second water-absorption elements 32. The second water-absorption elements 32 are also cylindrical elements made of water-absorbent materials such as sodium polyacrylate (SPA), super absorbent polymer (SAP), polyvinyl alcohol (PVA), cellulose sponge, polyurethane foam (PU foam), silicone sponge, or thermoplastic elastomer (TPE). The second water-absorption elements 32 are fixed on the positioning seats 31. Power elements 33 are provided at two ends of the positioning seats 31 to apply pressure to the second water-absorption elements 32, thereby improving water absorption efficiency.

The rail frame 4 has a closed end 41 and an open end 42. The open end 42 extends downward and is provided with a fixing seat 44 connected to the first side wall 11 and the second side wall 12, forming a rail. The open end 42 and the sliding section 43 directly face toward the passage 13 to facilitate the placement of umbrellas.

When a user inserts a wet umbrella into the rail frame 4 from the open end 42, the umbrella enters the passage 13 along the sliding section 43. At this time, the blocking sensor detects the umbrella and immediately sends a signal to the drive element 23. Upon receiving the signal, the drive element 23 activates and drives the linkage assembly 22. The axially rotatable elements 221 and the linkage elements 222 in the linkage assembly 22 interact to drive the first water-absorption elements 21 in the first water-absorption module 2 to start rotating.

As the first water-absorption elements 21 rotate, the umbrella placed with the passage 13 is passively guided into the gap between the first water-absorption elements 21 and the second water-absorption elements 32. Since the first water-absorption elements 21 and the second water-absorption elements 32 are made of highly water-absorbent materials, water on the umbrella is rapidly and thoroughly absorbed when the umbrella fully contacts the first water-absorption elements 21 and the second water-absorption elements 32.

Driven by the first water-absorption module 2, the umbrella continuously moves within the passage 13. During the movement, the umbrella repeatedly contacts new first water-absorption elements 21 and second water-absorption elements 32 to ensure that the water on the umbrella is completely dried. When the umbrella reaches the end of the passage 13 near the closed end 41, it indicates that the water on the umbrella is almost completely absorbed, and the user can retrieve the dried umbrella from the closed end 41.

During continuous operation of the continuous-operation umbrella drying machine, the first water-absorption elements 21 and the second water-absorption elements 32 continuously absorb water from the umbrella and simultaneously discharge water. To ensure that the first water-absorption elements 21 and the second water-absorption elements 32 can continuously operate efficiently and to prevent the water level in the accommodating space 14 from becoming too high and causing overflow, the continuous-operation umbrella drying machine performs automatic drainage as follows:

First, the power elements 33 receive a start signal and begin operation. The power elements 33 are typically driving devices such as electric motors or hydraulic cylinders and provide driving force. Under the drive of the power elements 33, the positioning seats 31 have relative movement. The movement of the positioning seats 31 drives the connected second water-absorption elements 32. The second water-absorption elements 32, driven by the positioning seats 31, form a non-parallel angle with the first water-absorption elements 21 and apply pressure to the first water-absorption elements 21. This squeezing action forces the water absorbed within the first water-absorption elements 21 and the second water-absorption elements 32 to be discharged. The discharged water flows into the accommodating space 14.

As water continues to be discharged, the water level in the accommodating space 14 rises until reaching the activation water level of the automatic drain valve 16. When the water level reaches the set value, the automatic drain valve 16 automatically opens to discharge excess water from the accommodating space 14 to the outside. The automatic drain valve 16 may be mechanically, electronically, or hydraulically actuated.

In summary, the continuous-operation umbrella drying machine of the present invention processes novelty or inventive step, and is therefore filed as an invention patent application in accordance with the law. However, the above description merely illustrates the preferred embodiment of the present invention, and any variations, modifications, changes, or equivalent substitutions derived from the technical means and scope of the present invention shall also fall within the scope of claims of the present invention.

What is claimed is:

1. A continuous-operation umbrella drying machine, comprising:
a base body having a first side wall and a second side wall, wherein a first recess and a second recess are respectively provided in the first side wall and the second side wall, a passage is provided between the first recess and the second recess, and an accommodating space in communication with the passage is provided at a bottom of the base body;
a first water-absorption module disposed within the first recess, including:
a plurality of first water-absorption elements, each having two ends respectively rotatably mounted to a top and a bottom of the first recess;
a linkage assembly connected to the plurality of first water-absorption elements; and
a drive element connected to the linkage assembly;
a second water-absorption module disposed within the second recess, including:
a plurality of positioning seats respectively connected to a top and a bottom of the second recess;
a plurality of second water-absorption elements, each having two ends respectively rotatably mounted on the positioning seats;
a rail frame, having a closed end and an open end, wherein a sliding section is provided between the open end and the closed end, and the open end extends downward and is connected to the first side wall and the second side wall such that the open end and the sliding section directly face toward the passage.

2. The continuous-operation umbrella drying machine as claimed in claim 1, wherein bottoms of the first recess and the second recess are respectively provided with a water-receiving plate.

3. The continuous-operation umbrella drying machine as claimed in claim 1, wherein a bottom of the base body is provided with an automatic drain valve.

4. The continuous-operation umbrella drying machine as claimed in claim 1, wherein the open end extends downward and is provided with a fixing seat connected to the first side wall and the second side wall.

5. The continuous-operation umbrella drying machine as claimed in claim 1, wherein the linkage assembly includes:
a plurality of axially rotatable elements, each assembled at one end of the plurality of first water-absorption elements; and
a plurality of linkage elements respectively connected to the plurality of axially rotatable elements.

6. The continuous-operation umbrella drying machine as claimed in claim 5, wherein the plurality of axially rotatable elements and the plurality of linkage members are combinations of a plurality of gears and a plurality of racks, a plurality of gears and a plurality of chains, or a plurality of pulleys and a plurality of belts.

7. The continuous-operation umbrella drying machine as claimed in claim 1, wherein two ends of the positioning seat are provided with a power element.

8. The continuous-operation umbrella drying machine as claimed in claim 1, wherein a position where the passage directly faces toward the open end is defined as an entrance, and a position where the passage directly faces toward the closed end is defined as an exit.

9. The continuous-operation umbrella drying machine as claimed in claim 1, wherein the drive element is further electrically connected to a blocking sensor, and the blocking sensor is connected to the first side wall or the second side wall.

10. The continuous-operation umbrella drying machine as claimed in claim 1, wherein the first water-absorption module and the second water-absorption module are cylindrical modules made of sodium polyacrylate (SPA), super absorbent polymer (SAP), polyvinyl alcohol (PVA), cellulose sponge, polyurethane foam (PU foam), silicone sponge, or thermoplastic elastomer (TPE).
